(19) United States
(12) Patent Application Publication
(10) Pub. No.: US 2014/0037392 A1
(43) Pub. Date: Feb. 6, 2014

(54) Dust Collection Hood of Electric Hand Tool

(71) Applicant: Wen Liang Lo, Tainan City (TW)

(72) Inventor: Wen Liang Lo, Tainan City (TW)

(21) Appl. No.: 13/567,132

(22) Filed: Aug. 6, 2012

(51) Int. Cl. B23B 45/00

(52) U.S. Cl. 408/67

(57) ABSTRACT

A dust collection hood of an electric hand tool includes a hollow transparent hood body, with a flexible external wall, an end coupled to a hollow socket, a snap portions protruded from an internal wall of the socket and corresponding to a fixing end of the electric hand tool, such that the socket can be snapped to the fixing end of the electric hand tool, and an isolation portion formed at the middle of the hood body and having a through hole formed at the middle of the isolation portion for passing a drill bit of the electric hand tool, and the dust collection hood is provided for collecting dust, while isolating the dust from an actuating end of the electric hand tool, so as to prevent the dust from entering into the actuating end and preventing the dust from flying around in the air.

### BACKGROUND OF THE INVENTION

1. Field of the Invention

The present invention relates to a dust collection hood of an electric hand tool, and more particularly to the dust collection hood for preventing dust from entering into an actuating end of an electric hand tool and preventing the dust from flying around in the air, when the electric hand tool is used for drilling a hole.

2. Description of the Related Art

In general, a drill bit of an electric hand tool is secured to an actuating end of the electric hand tool for drilling a hole on a wall or a wooden board, and then the drill bit of the electric hand tool is attached onto the wall or the wooden board for drilling the hole. However, a large quantity of dust is produced during the process of drilling the hole by the electric hand tool, and users have to clean up the working site after using the electric hand tool, thus causing inconvenience to the users. In addition, dust may enter into the actuating end of electric hand tool and affect the service life of the hand tool. Obviously, the conventional electric hand tool requires improvements.

### SUMMARY OF THE INVENTION

In view of the aforementioned drawbacks of the prior art, the inventor of the present invention based on years of experience in the related industry to conduct extensive researches and experiments, and finally invented the present invention to overcome the drawbacks of the prior art.

In view of the aforementioned drawbacks, the inventor of the present invention based on years of experience in the related industry to conduct extensive researches and experiments, and finally developed a dust collection hood of an electric hand tool of the present invention.

Therefore, it is a primary objective of the present invention to provide a dust collection hood of an electric hand tool capable of preventing the dust from entering into the actuating end and preventing the dust from flying around in the air when the electric hand tool is used for drilling a hole.

To achieve the aforementioned objective, the present invention provides a dust collection hood of an electric hand tool, comprising a hollow transparent hood body, with a flexible external wall, an end coupled to a hollow socket, a snap portions protruded from an internal wall of the socket and corresponding to a fixing end of the electric hand tool, such that the socket can be snapped to the fixing end of the electric hand tool, and an isolation portion formed at the middle of the hood body, and the isolation portion having a through hole formed at the middle of the isolation portion for passing out a drill bit of the electric hand tool, such that when the electric hand tool is used for drilling a hole, the dust collection hood is provided for collecting dust, while isolating the dust from an actuating end of the electric hand tool, so as to prevent the dust from entering into the actuating end and preventing the dust from flying around in the air.

In the aforementioned dust collection hood of an electric hand tool, the hollow socket and the hood body are coupled by screwing an external thread formed on an external wall of the front of the hollow socket and an internal thread formed pm a corresponding internal wall of the hood body to engage the internal thread of the hood body with the external thread of the socket.

In the aforementioned dust collection hood of an electric hand tool, an attaching portion is extended inwardly from a front end of the hood body.

In the aforementioned dust collection hood of an electric hand tool, the hood body includes a spring installed therein and coupled to an internal wall of the hood body.

In the aforementioned dust collection hood of an electric hand tool, the socket is made of plastic.

In the aforementioned dust collection hood of an electric hand tool, the hood body has a tapered diameter from one end of the hollow socket to the other opposite end of the hollow socket.

In the aforementioned dust collection hood of an electric hand tool, the isolation portion in a V-shape with a pointed end aligned towards the attaching portion of the hood body.

### BRIEF DESCRIPTION OF THE DRAWINGS

FIG. 1 is an exploded view of a first preferred embodiment of the present invention;

FIG. 2 is a cross-sectional exploded side view of the first preferred embodiment of the present invention;

FIG. 3 is a first schematic view of an application of the first preferred embodiment of the present invention;

FIG. 4 is a second schematic view of an application of the first preferred embodiment of the present invention;

FIG. 5 is a third schematic view of an application of the first preferred embodiment of the present invention;

FIG. 6 is a cross-sectional exploded side view of a second preferred embodiment of the present invention; and

FIG. 7 is a schematic view of an application of the second preferred embodiment of the present invention.

### DETAILED DESCRIPTION OF THE PREFERRED EMBODIMENTS

The objectives, technical characteristics, measures, effects and advantages of the present invention will become apparent with the detailed description of preferred embodiment accompanied with the illustration of related drawings as follows.

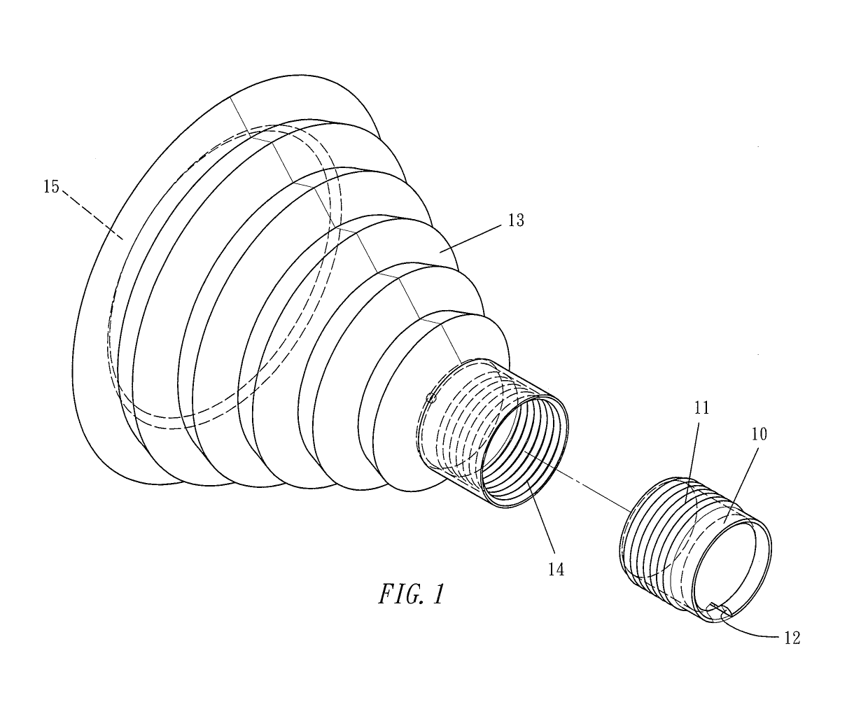

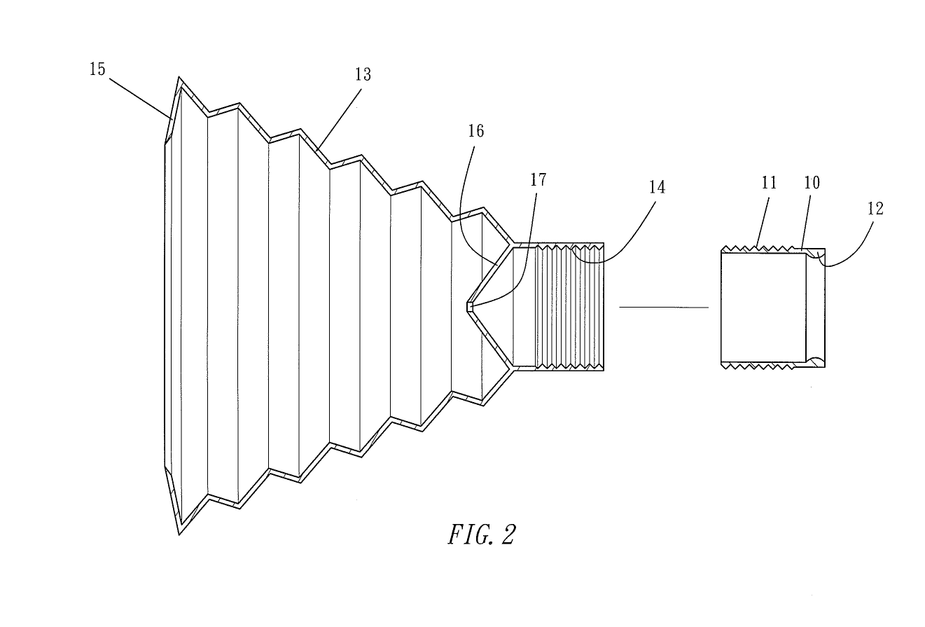

With reference to FIGS. 1 to 3 for a dust collection hood of the first preferred embodiment of the present invention, the dust collection hood comprises:

a hollow socket 10, made of plastic, and capable of coupling a fixing end 20 of an electric hand tool 2, and having an actuating end 21 disposed at the front of the fixing end 20 and coupled to a drill bit 22. The socket 10 has an external thread 11 formed on an external wall of the front of the socket 10 and corresponding to an external side of the fixing end 20 of the electric hand tool 2, and a snap portion 12 protruded from an internal wall of the socket 10 and provided for snapping with the fixing end of the electric hand tool 2; and

a hood body 13, being a transparent hollow body, with an inner side of an end coupled to the hollow socket 10, and having an internal diameter tapered from one end of the hollow socket 10 to the other end of the hollow socket 10, and the hood body 13 having an elastic wrinkled wall, such that the compressed hood body 13 can resume its original position after being released. The hood body 13 coupled to an internal wall of the hollow socket 10 has an internal thread 14, so that the internal thread 14 can be screwed with an external thread 11 of socket 10. An attaching portion 15 is bent inwardly and extended from a front end of an external side of the hood body 13 with the largest diameter, and an aslant (V-shaped) isolation portion 6 is formed at the middle inside the hood body 13 and slantingly extended towards an external end of the hood body 13 with the largest diameter and has a through hole 17 formed at the middle of the isolation portion 6 and provided for passing out the drill bit 22 of the electric hand tool 2.

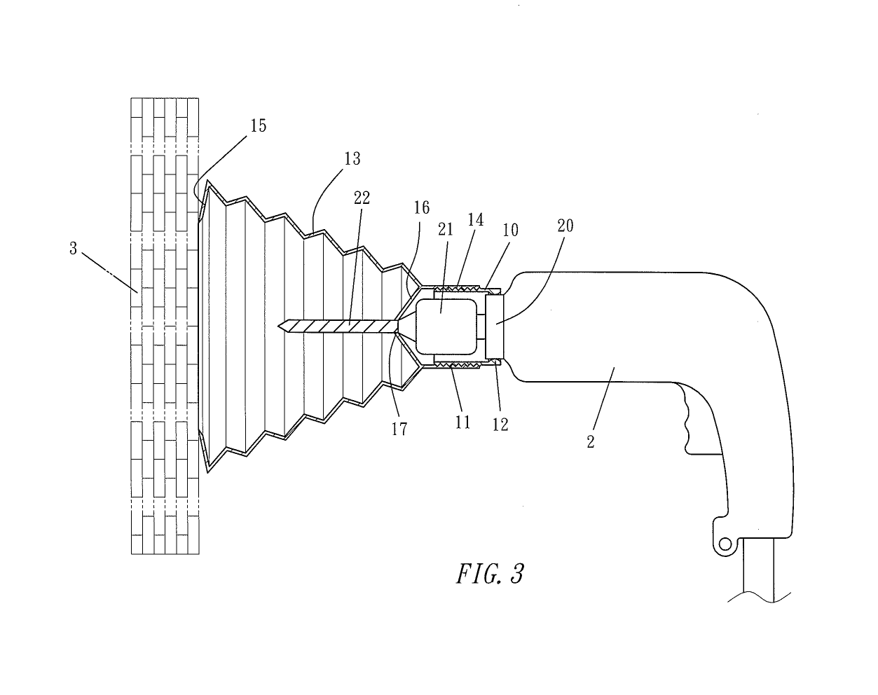

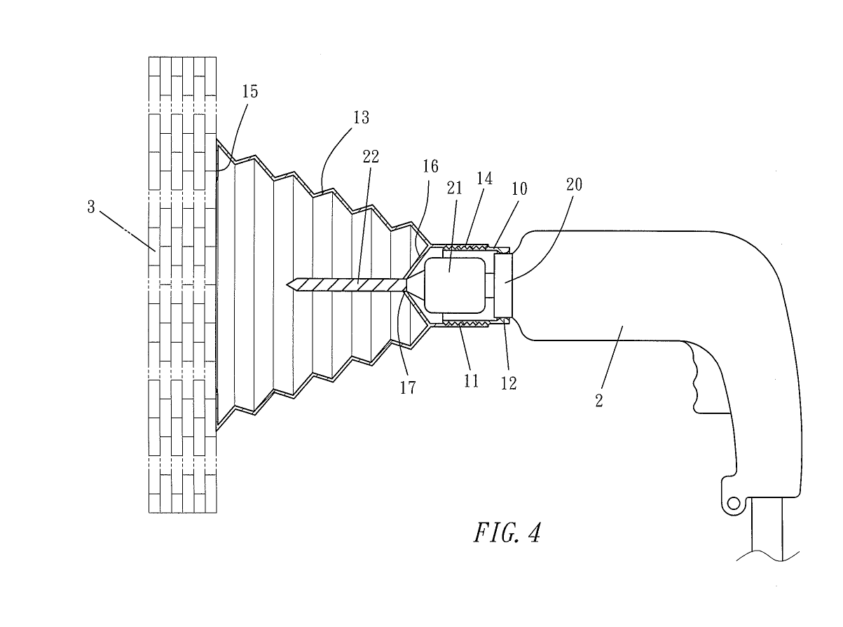

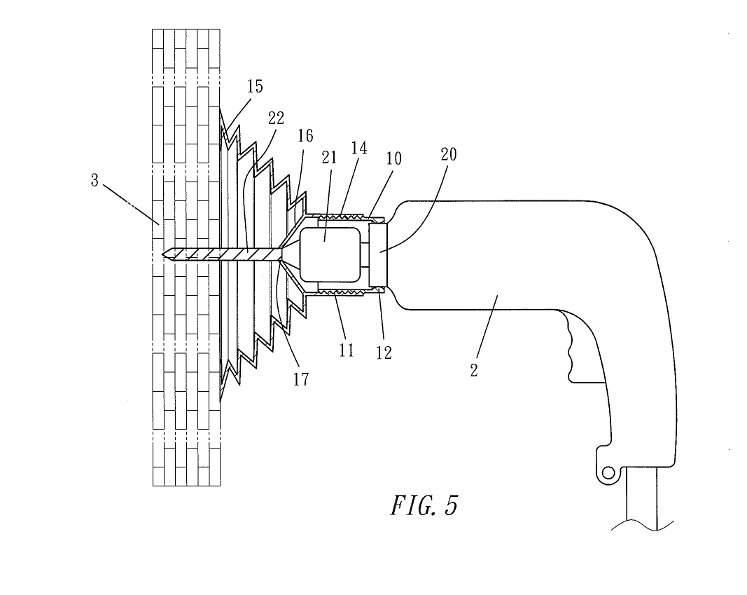

With reference to FIGS. 3 to 5, the internal thread 14 of the dust collection hood 13 is screwed with the external thread 11 of the socket 10. When use, the snap portion 12 of the socket 10 is snapped to the fixing end 20 of the electric hand tool 2 to couple the hood body 13 to the fixing end 20 of the electric hand tool 2, such that the attaching portion 15 of the hood body 13 is attached onto a wall 3, and then the electric hand tool 2 is pushed towards the wall 3 to compress the hood body 13 to abut the drill bit 22 of the electric hand tool 2 against the wall, so as to start drilling a hole on the wall 3. The hood body 13 can be provided for observing the operation of the drill bit 22, and dust produced from the drilling falls into the hood body 13 and is isolated by an isolation portion 16. Since the drill bit 22 of the electric hand tool 2 is extended out from the through hole 17 of the isolation portion 16 of the hood body 13, the isolation portion 16 of the hood body 13 can isolate the dust from the actuating end 21 of electric hand tool 2 to prevent the dust from entering into the actuating end 21 of the electric hand tool 2 to extend the service life of the electric hand tool 2. In addition, the dust collection hood is flexible, so that the drill bit 22 of the electric hand tool 2 can drill a hole at different angles.

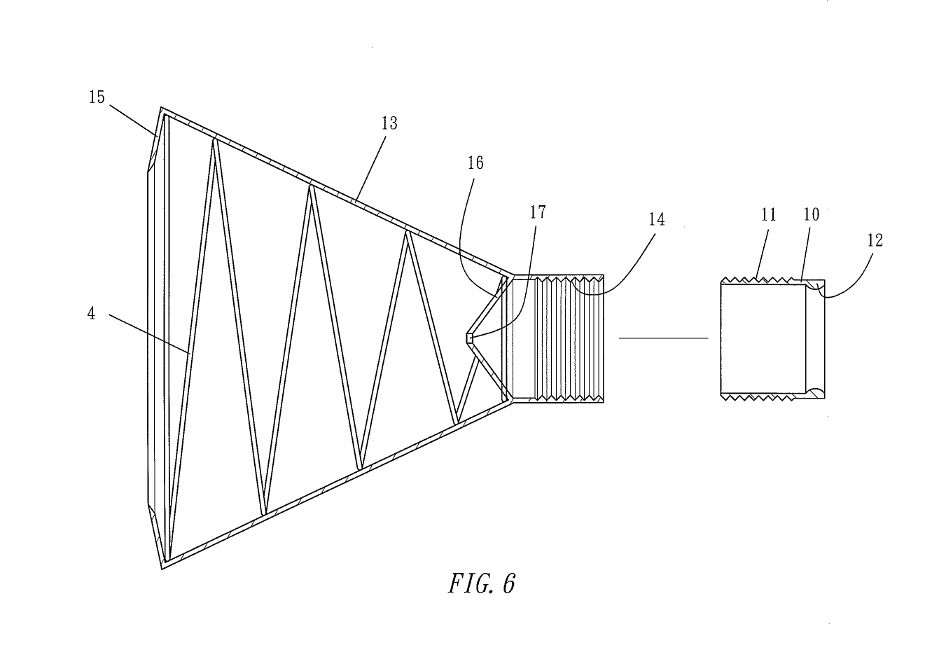

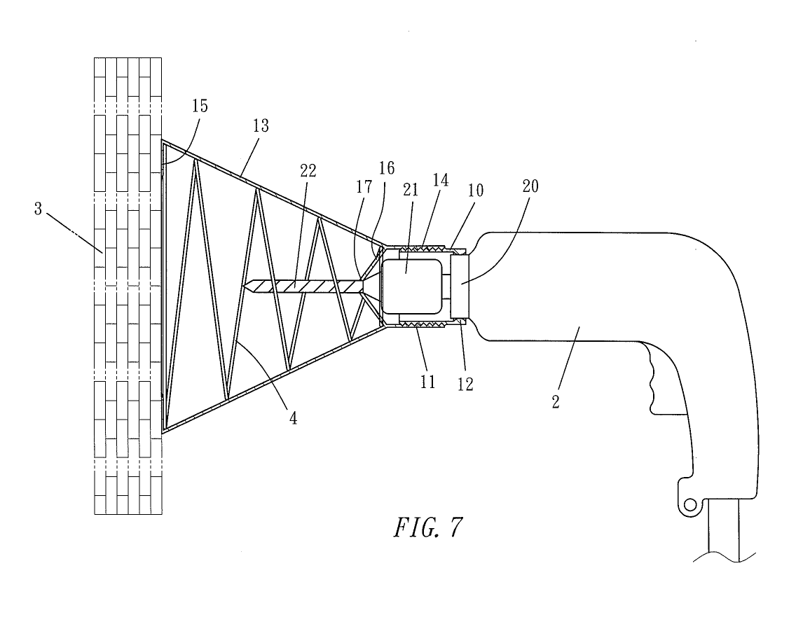

With reference to FIGS. 6 and 7 for the second preferred embodiment of the present invention, the difference between the second preferred embodiment and the first preferred embodiment resides on that the wall of the hood body 13 has no wrinkle, and the hood body 13 without wrinkles has a spring 4 installed therein and coupled to an internal wall of the hood body 13, such that the hood body 13 after being pressed can resume its original position. The using method and functions of the second preferred embodiment are the same as those of the first preferred embodiment, and thus will not be repeated.

Therefore, the dust collection hood and the fixing end 20 of the electric hand tool 2 can be coupled, so that the isolation portion 16 disposed in the dust collection hood can isolate dust to prevent the dust from entering into the actuating end 21 of the electric hand tool 2 and extend the service using life of the electric hand tool 2.

In summation of the description above, the present invention achieves the expected objectives and effects and complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A dust collection hood of an electric hand tool, comprising a hollow transparent hood body, with a flexible external wall, an end coupled to a hollow socket, a snap portions protruded from an internal wall of the socket and corresponding to a fixing end of the electric hand tool, such that the socket can be snapped to the fixing end of the electric hand tool, and an isolation portion formed at the middle of the hood body, and the isolation portion having a through hole formed at the middle of the isolation portion for passing out a drill bit of the electric hand tool.

2. The dust collection hood of an electric hand tool according to claim 1, wherein the socket has an external thread formed on an external wall of the socket, and the hood body has an internal thread formed at a rear side of an internal wall of the hood body, and the internal thread of the hood body is screwed with the external thread of the socket.

3. The dust collection hood of an electric hand tool according to claim 1, wherein the hood body is disposed at a front end of another opposite end of the hollow socket, an the hood body has an inwardly extended attaching portion.

4. The dust collection hood of an electric hand tool according to claim 1, wherein the socket is made of plastic.

5. The dust collection hood of an electric hand tool according to claim 1, wherein the hood body has a tapered diameter from one end of the hollow socket to the other opposite end of the hollow socket.

6. The dust collection hood of an electric hand tool according to claim 1, wherein the isolation portion in a V-shape with a pointed end aligned towards the attaching portion of the hood body.

7. The dust collection hood of an electric hand tool according to claim 1, wherein the hood body includes a spring installed on an internal wall of the hood body.

8. The dust collection hood of an electric hand tool according to claim 1, wherein the hood body has a wrinkled external wall.
